(19) United States
(12) Patent Application Publication
(10) Pub. No.: US 2009/0049050 A1
(43) Pub. Date: Feb. 19, 2009

(54) FILE-BASED HORIZONTAL STORAGE SYSTEM

(76) Inventor: Jeff Whitehead, San Jose, CA (US)

Correspondence Address: Xin Wen, 2800 Bridge Parkway, Redwood City, CA, 94065, US

(21) Appl. No.: 11/839,144

(22) Filed: Aug. 15, 2007

(51) Int. Cl. G06F 17/30

(52) U.S. Cl. 707/10; 707/102; 707/200; 707/E17.005; 707/E17.01; 707/E17.044

(57) ABSTRACT

A file-based storage system includes a upload server configured to receive data files, a data buffer configured to store the data files received by the upload server, a plurality of first file silos each configured to store at least a portion of the data files received by the upload server, a parity builder configured to compute parity data corresponding to the portions of the data files stored in the plurality of first file silos; and a second file silo configured to store parity data.

### BACKGROUND

In recent years, photography has been rapidly transformed from chemical based technologies to digital imaging technologies. Digital images captured by digital cameras can be stored in computers and viewed on electronic display devices. A user can upload digital images to a central network location provided by an image service provider such as Shutterfly, Inc. at www.shutterfly.com. A user can store, organize, manage, edit, enhance, and share digital images at the central network location using a web browser or software tools provided by the service provider. A user can electronically share images she uploaded with her family members and friends. A user can also design and order image-based products from the image service provider. The image-based products can include image prints, photo books, photo calendars, photo greeting cards, holiday cards, photo mugs, and photo T-shirts using image content provided by the user. The image-based products can be created for the user or as photo gifts for others. A high degree of personalization is desirable in the image-based products to make them memorable to the users or to the photo gift recipients.

A challenge facing network based imaging services is the need for storing rapidly increasing amount of image data uploaded by digital camera owners. The increase in the image data is a result of a number factors including an expanded base of digital cameras, increased average number of digital images taken by a digital camera owner, as well as increased image sensor size in the digital cameras.

An approach to store a large of amount of data is to use Redundant Array of Independent Disks (RAID). A data file can be separated into a number of data blocks that each can be stored on a separate hard disk. The parity of the data blocks from the same data file can be computed and stored on yet another different hard disk. The parity data can be used for data repairs in the events that one of the disks for storing a data block in the data file fails such that data can be recovered when a single disk fails. When an error occurs on a disk in a RAID system, the error can be detected even when the disk itself is unable to detect the error. Data integrity can thus be improved. Disk failures can be automatically repaired invisible to the end users.

### SUMMARY

In one aspect, the present application relates to a file-based storage system includes

a upload server configured to receive data files, a data buffer configured to store the data files received by the upload server, a plurality of first file silos each configured to store at least a portion of the data files received by the upload server, a parity builder configured to compute parity data corresponding to the portions of the data files stored in the plurality of first file silos; and a second file silo configured to store parity data.

In another aspect, the present application relates to a file-based storage system that includes a upload server configured to receive data files, a plurality of first file silos each configured to store at least a portion of the data files received by the upload server; a parity builder configured to compute parity data corresponding to the portions of the data files stored in the plurality of first file silos; a second file silo configured to store parity data; a parity file storage configured to store a status of the parity data, said status includes the completion of the computation of the parity data for the data files stored in the plurality of first file silos, and a data buffer configured to store the data files received by the upload server, wherein the parity builder is configured to delete the data files in the data buffer when the status is stored in the parity file storage.

In another aspect, the present application relates to a method for storing data files. The method includes storing data files in a data buffer, storing the data files in a plurality of first file silos, determining the workload of at least one of the plurality of the first file silos, computing parity data for the data files stored in the plurality of first file silos if the workload is below a threshold value, storing the parity data in a second file silo; and deleting the data files in the data buffer.

Implementations of the system may include one or more of the following. The file-based storage system can further include a parity file storage configured to store the status of the parity data of the data files. The status can indicate whether a parity data for a data file is stored in the second file silo. The file-based storage system can further include a transfer server configured to store the parity data computed by the parity builder in the second file silo. The parity builder can compute parity data in accordance with the workloads of at least one of the plurality of the first file silos. The parity builder can delete the data files from the data buffer after the parity data is computed and stored in the second file silo. The data buffer can be a circular buffer. The data files can include file types compatible with Windows, MAC, and UNIX operating systems. At least one of the plurality of the first file silos can store more than a thousand data files. The second file silo can store a first portion of parity data for a first group of first file silos and to store a second portion of parity data for a second group of second file silos.

Embodiments may include one or more of the following advantages. The disclosed systems and methods can flexibly store a large number of date files in variable sizes in comparison to the constant data block size in some conventional data storage systems. Each data file can include different data formats and different file formats.

The disclosed systems can also provided improved redundancy and thus data security. A data buffer can temporarily store newly received data files before parity data is computed and stored, which ensures data redundancy as soon as the data files are received. Parity data can be built on overlapping parity file groups to provide extra redundancy comparing to some conventional systems.

The disclosed systems provide increased capacity and data storage efficiency. Data file parities can be built and stored asynchronously during low server load levels thus allowing fast read and write speed during high server load periods. The status of the data parity computation and storage are tracked and timely updated in a parity file storage, which further ensures the redundancy is provided to data storage to all the stored data files.

The disclosed systems are also scalable. The data are stored at a file level instead of at a data block level, which allows easy scaling up a large amount data in different formats across file silos. Additional file Silos can easily be added to store incremental data while allowing appropriate parity build without affecting previous file configurations.

### BRIEF DESCRIPTION OF THE DRAWINGS

FIG. 1 is a block diagram of a system for producing personalized image-based products.

FIG. 2 shows a typical user's computer used with the system of FIG. 1.

FIG. 3 is a block diagram of a file-based horizontal storage system.

FIG. 4 is a flow chart for the operations of the file-based horizontal storage system of FIG. 3.

FIG. 5 is a block diagram of a file-based horizontal storage system with increased storage capacity in the file silos.

Although the invention has been particularly shown and described with reference to multiple embodiments, it will be understood by persons skilled in the relevant art that various changes in form and details can be made therein without departing from the spirit and scope of the invention.

### DETAILED DESCRIPTION

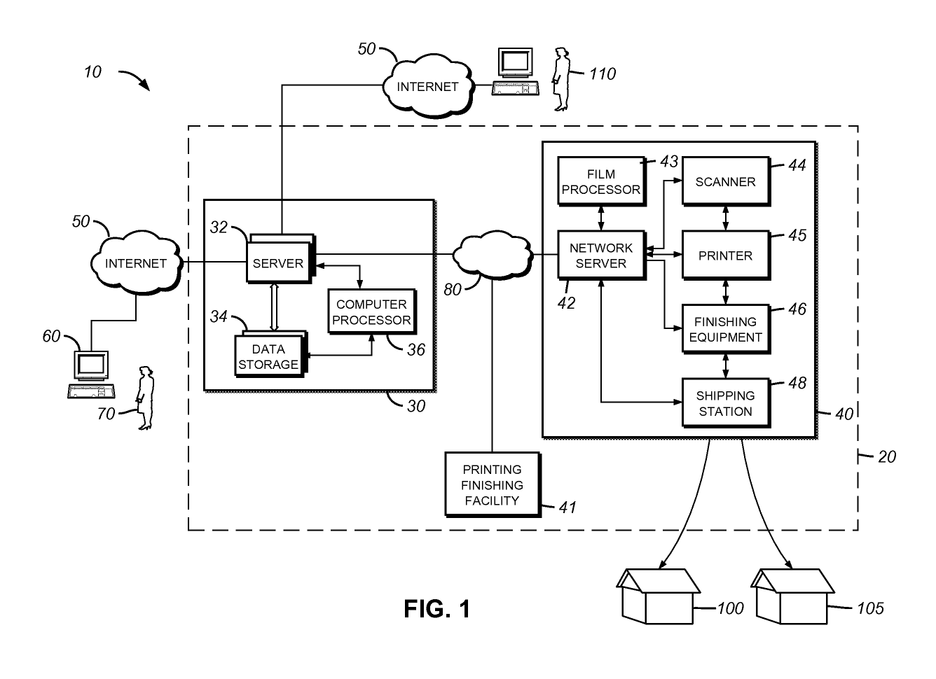

FIG. 1 shows a block diagram of a system 10 for producing personalized image-based products. An online photo system 20 can be established by an image service provider to provide image services and products on a wide area network such as the Internet 50. The online photo system 20 can include a data center 30, one or more printing and finishing facilities 40 and 41, and a computer network 80 that can facilitate the communications between the data center 30 and the finishing facilities 40 and 41.

In the present specification, the term “personalized” is used in personalized content, personalized messages, personalized images, and personalized designs that can be incorporated in the personalized products. The term “personalized” refers to the information that is specific to the recipient, the user, the gift product, or the intended occasion. The content of personalization can be provided by a user or selected by the user from a library of content provided by the image-server provided. The content provided can include stock images and content licensed from a third party. The term “personalized information” can also be referred to as “individualized information” or “customized information”. Examples of personalized image-based products may include personalized photo greeting cards, photo prints, photo books, photo T-shirt, and photo, mugs etc. The personalized image-based products can include users' photos, personalized text, and personalized designs.

The term “photo book” refers to books that include one or more pages and at least one image on a book page. A photo books can include a photo albums, a scrapbook, a photo calendar book, or a photo snapbook, etc. The photo book in the disclosed system can include personalized image and text content provided by a user or by a third party. A “photo-book kit” in the disclosed system refers to a photo book comprising personalized content as described above, as well as one or more book accessories such as a slip case for a book, a book insert such as a bookmark, and a dust jacket. The “photo-book kit” in the disclosed system can include personalized content on the book pages, the book cover, and the book accessories.

The data center 30 can include one or more servers 32, data storage devices 34 for storing image data, user account and order information, and one or more computer processors 36 for processing orders and rendering digital images. An online-photo website can be powered by the servers 32 to serve as a web interface between the users 70 and the image service provider. The users 70 can order image-based products from the web interface. The printing and finishing facilities 40 and 41 can produce the ordered image-based products such as photographic prints, greeting cards, holiday cards, post cards, photo albums, photo calendars, photo books, photo T-shirt, photo mugs, photo aprons, image recording on compact disks (CDs) or DVDs, and framed photo prints.

The architecture of the data storage devices 34 is designed to optimize the data accessibility, the storage reliability and the cost. Further details on the image data storage in online photo system 20 are provided in the commonly assigned U.S. Pat. No. 6,839,803, titled “Multi-Tier Data Storage System”, which is incorporated herein by reference.

The printing and finishing facilities 40 and 41 can be co-located at the data center 30. Alternatively, the printing and finishing facility 40 and 41 can be located remotely from the data center 30. The printing and finishing facilities 40 and 41 can be set up. Each printing and finishing facility 40 or 41 can be geographically located close to a large population of customers to shorten order delivery time. Furthermore, the printing and finishing facilities 40 and 41 and the data center 30 can be operated by different business entities. For example, a first business entity can own the data center 30 and host the website that can be accessed by the users 70. The printing and finishing facilities 40 and 41 can be owned and operated by a second business entity, which can be referred as an Application Service Provider (ASP), responsible for fulfilling the image-based products ordered through at the website.

The printing and finishing facility 40 can include one or more network servers 42, printers 45 for printing images on physical surfaces, finishing equipment 46 for operations after the images are printed, and shipping stations 48 for confirming the completion of the orders and shipping the ordered image-based products to the user 70 or recipients 100 and 105. The one or more network servers 42 can communicate with the data center 30 via the computer network 80 and facilitate the communications between different devices and stations in the printing and finishing facility 40. The computer network 80 can include a Local Area Network, a Wide Area Network, and wireless communication network.

The printers 45 can receive digital image data and control data, and reproduce images on receivers. The receivers can be separate photo prints, or pages to be incorporated into photo books. Examples of the printers 45 include can be digital photographic printers such as Fuji Frontier Minilab printers, Kodak DLS minilab printers, Imaging Solutions CYRA FastPrint digital photo printer, or Kodak I-Lab photo printers. The printers 45 can include offset digital printers or digital printing presses such as HP Indigo digital printing press, Xerox's iGen printer series, etc. The printers 45 can also include large format photo or inkjet printers for printing posters and banners. The printing and finishing facilities 40 and 41 can include a film processor 43 for processing exposed films, and a scanner 44 for digitizing processed film stripes. The order information and image data can be transferred from servers 32 to the network servers 42 using a standard or a proprietary protocol (FTP, HTTP, among others).

The finishing equipment 46 can perform operations for finishing a complete image-based product other than printing, for example, cutting, folding, adding a cover to photo book, punching, stapling, gluing, binding, envelope printing and sealing, packaging, labeling, package weighing, and postage metering. The finishing operations can also include framing a photo print, recording image data on a CD-ROM and DVD, making photo T-shirts and photo mugs, etc. Furthermore, the printers 45 and the finishing equipments 46 can reside at different locations.

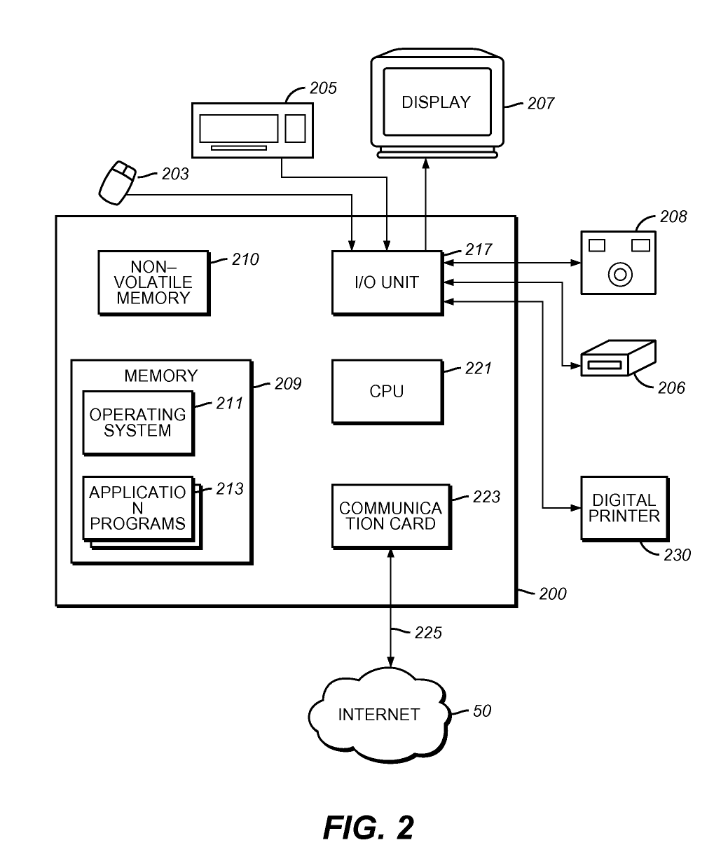

A user 70 can access the online-photo website using a computer terminal 60 as shown in FIG. 1. The computer terminal 60 can be a personal computer, a portable computer device, or a public entry terminal such as a kiosk. The computer terminal 60 allows a user 70 to execute software to perform tasks such as communicating with other computer users, accessing various computer resources, and viewing, creating, or otherwise manipulating electronic content, that is, any combination of text, images, movies, music or other sounds, animations, 3D virtual worlds, and links to other objects. Exemplary components of the computer terminal 60, shown in FIG. 2, include input/output (I/O) devices (mouse 203, keyboard 205, display 207) and a general purpose computer 200 having a central processor unit (CPU) 221, an I/O unit 217 and a memory 209 that stores data and various programs such as an operating system 211, and one or more application programs 213 including applications for viewing, managing, and editing digital images (e.g., a graphics program such as Adobe Photoshop). The computer 200 also includes non-volatile memory 210 (e.g., flash RAM, a hard disk drive, and/or a USB memory card, a floppy disk, a CD-ROM, a DVD, or other removable storage media), and a communications device 223 (e.g., a modem or network adapter) for exchanging data with an Internet 50 via a communications link 225 (e.g., a telephone line).

The computer 200 allows the user 70 to communicate with the online-photo website using the wired or wireless communication card or device 223. The user 70 can set up and access her personal account. The user 70 can enter user account information such as the user's name, address, payment information (e.g. a credit card number), and information about the recipient of the image-based products. The user 70 can also enter payment information such as credit card number, the name and address on the credit card etc. The user 70 can upload digital images to the online-photo website. The user can store the images in an online photo album, create personalized image-based product at the web user interface, and order a personal image-based product and a gift product for specified recipients 100 and 105.

The computer 200 can be connected to various peripheral I/O devices such as an image capture device (digital camera, film scanner or reflective scanners). The peripheral device can be a digital camera 208. The digital images captured by a digital camera are typically stored in a memory card or a memory stick (e.g., SmartMedia™ or CompactFlash™) that are detachable from the digital camera. The digital images on the memory card can be transferred to o a non-volatile memory 210 using a card reader 206. The digital camera 208 can also be directly connected to the computer 200 using a Firewire or an USB port, a camera docking station, or a wireless communication port to allow digital images to be transferred from the memory on the detail camera to the computer's disk drive or the non-volatile memory 210.

The user 70 can also obtain digital images from film-based prints from a traditional camera, by sending an exposed film into a photo-finishing service, which develops the film to make prints and/or scans (or otherwise digitizes) the prints or negatives to generate digital image files. The digital image files then can be downloaded by the user or transmitted back to the user by e-mail or on a CD-ROM, diskette, or other removable storage medium. The users can also digitize images from a negative film using a film scanner that is connected to the computer 200 or from a reflective image print using a scanner. Digital images can also be created or edited using an image software application 213 such as Adobe Photoshop.

Once the digital images are stored on the computer 200, a user can perform various operations on the digital images using application programs 213 stored in memory 209. For example, an image viewer application can be used for viewing the images and a photo editor application can be used for touching up and modifying the images. An electronic messaging (e.g., e-mail) application can be used to transmit the digital images to other users. The application programs 213 can also enable the user 210 to create a personalized image-based product on the computer 200. Several of the above described imaging functions can be incorporated in a client software application that can be installed on a user's computer 200.

In addition to viewing the digital images on the computer display 207, the user 70 may desire to have physical image-based products made of digital images. Prints can be generated by the user 70 using a digital printer 230 that is connected to the computer 200. Typical digital printers 230 can include such as an inkjet printer or a dye sublimation printer. The user 70 can also purchase image-based products from the online image service provider. The production of these image-based products often require the use of commercial equipment which are usually only available at a commercial production location such as the printing and finishing facilities 40 and 41. An example for the online image service providers is Shutterfly, Inc., located at Redwood City, Calif.

The user 70 can be a consumer that accesses the computer terminal 60 from home or a public entry terminal. The user 70 can also be a business owner or employee that may access the computer terminal 60 at a retail location such as a photo shop or a printing store. The disclosed system is compatible with a retail imaging service using a local computer 200 at the point of sales, or an online photo system wherein a user 70 access a server 32 using a remote computer terminal 60. The formats of communication between the computer terminal 60 and the servers 32 as well as the graphic user interface can be customized for the consumer and commercial customers.

The computer terminal 60 can also be a public entry terminal such as a kiosk for receiving digital image data from the user 70 and uploading the digital images to the server 32. After the digital image files have been uploaded, the user can view, manipulate and/or order prints in the manners described above. The public entry terminal can also support various electronic payment and authorization mechanisms, for example, a credit or debit card reader in communication with a payment authorization center, to enable users to be charged, and pay for, their prints at the time of ordering.

An exemplified process of using the online image service can include the following. The user 70 sends digital images to the servers 32 provided by the online photo system 20 by uploading over the Internet 50 using a standard or a proprietary protocol (FTP, HTTP, XML, for example) or electronic communication application (for example, e-mail or special-purpose software provided by the photo-finisher). The user 70 can also send digital image data stored on an electronic storage medium such as a memory card or recordable CD by US mail, overnight courier or local delivery service. The photo-finisher can then read the images from the storage medium and return it to the user, potentially in the same package as the user's print order. The image service provider can load data or programs for the user's benefit onto the storage medium before returning it to the user. For example, the photo-finisher can load the storage medium with an application program 213 for the user to create a personalized image-based product on his computer 200.

The user 70 can also send a roll of exposed film, and processed film negatives to the image service provider. The exposed film is processed by the film processor 43 and digitized by the scanner 44 in the printing and finishing facilities 40 and 41. The digital image data output from the scanner 44 is stored on the data storage 34.

After the image service provider has received the user's digital images, the image service provider can host the images on the online photo website, at which the user can view and access the images using a web browser or a locally installed software application. The user 70 can access the online-photo website to create and design a photo-based product such as a photo book and a photo greeting card, and specify the images to be reproduced on an image-based product and parameters relating to printing (e.g., finish, size, number of copies). The user 70 can also designate one or more recipients 100 and 105 to whom the image-based products are to be sent.

After the user's images have reached the image service provider and have been made available online, the user can place an order with the image service provider. One way to place an order is by having the user 70 view the images online, for example, with a browser and selectively designate which images should be printed. The user can also specify one or more recipients 100 and 105 to whom prints should be distributed and, further, print parameters for each of the individual recipients, for example, not only parameters such as the size, number of copies and print finish, but potentially also custom messages to be printed on the back or front of a print. The user 70 can also authorize a recipient 110 to receive the user's images electronically by entering the recipient 110's email address and other electronic identifications.

The information entered by the user 70 can be stored on the server 32 and the data storage 34, and subsequently transmitted to a printing and finishing facility 40 or 41 for making the image-based products. The image-based products can include photographic prints, but also any other item to which graphical information can be imparted, for example, greeting or holiday cards, books, greeting cards, playing cards, T-shirts, coffee mugs, mouse pads, key-chains, photo collectors, photo coasters, or other types of photo gift or novelty item. The image-based products are printed by the printer 45 and finished by finishing equipment 46 according to the printing parameters as specified by the user 70. The image-based products are then delivered to the specified recipients 100 and 105 using standard U.S. Mail, or courier services such as Federal Express and UPS.

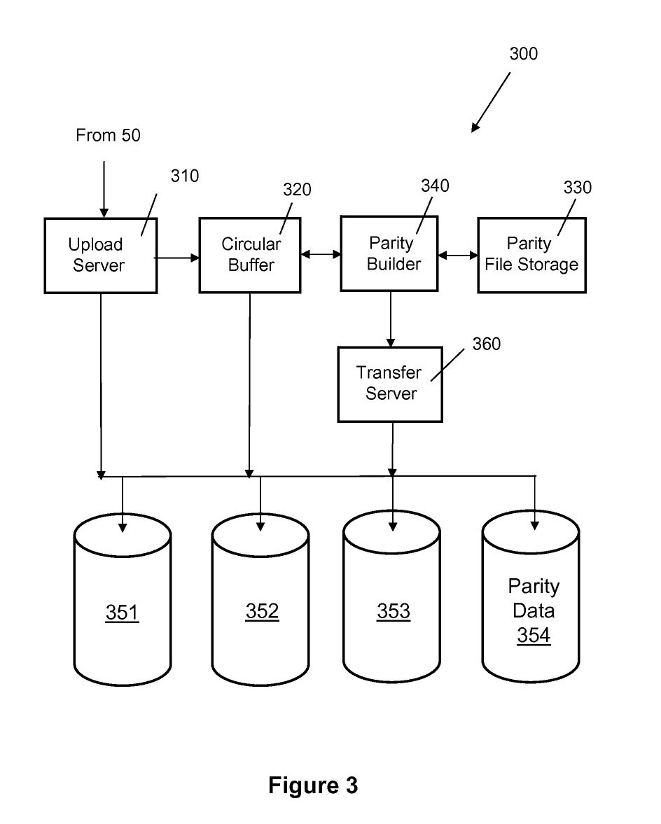

A file-based horizontal storage system 300 that is compatible with the data center 30, referring to FIG. 3, can include an upload server 310, a circular buffer 320, a parity file storage 330, a parity builder 340, a plurality of file silos 351-353, and transfer server 360. Each of the file silos 351-353 can store a plurality of data files that can be in different file types and formats such as date files supported by different operating systems such as Windows, MAC OS, Linux, and UNIX. The file formats can include for example, JPEG, .RAW, .PPT, .DOC, .PDF, etc. Each file silo 351, 352, or 353 can store thousands to millions of such data files. The file-based horizontal storage system 300 can also support multiple versions of files, or just storing the differences between different versions of files. One of the file silos (e.g. file silo 354) can store parity data of the data files in the other file silos 351 353. The parity builder 340 can be a computer processor (or a server) that is installed with a software application that can compute parity of data stored at different locations.

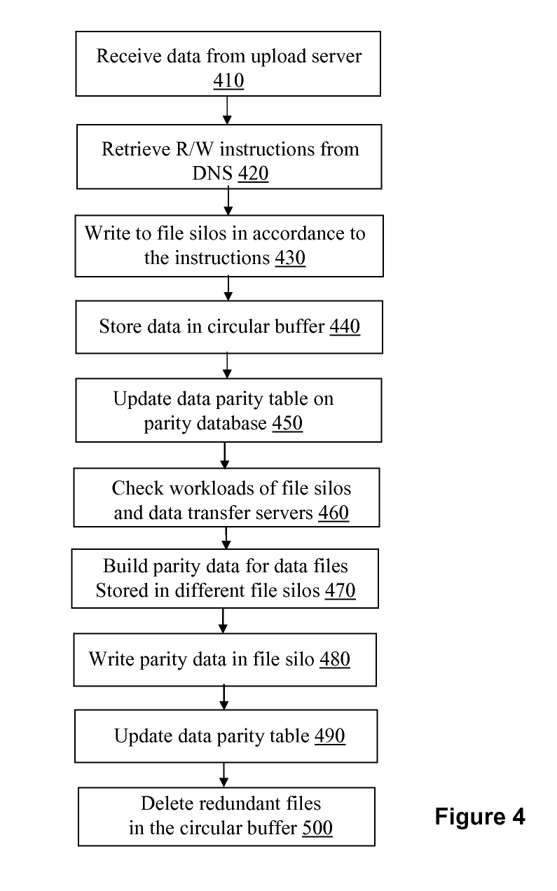

In operation, referring to FIGS. 3 and 4, data files can be uploaded from the Internet 50 and received by the upload server 310 (step 410). The data files can include different types and different formats. The read and write (R/W) instructions can be retrieved from the domain name system (DNS) associated with the uploaded data files to determine the web addresses of the file silos where the data files are to be stored (step 420). The data files are written to the file silos 351-353 if the DNS instructions specify the file silos 351-353 to the target storage locations (step 430). The amount of the data stored in the file silos 351-353 can be distributed between the file silos 351-353.

The newly uploaded data files are also temporarily stored in a circular buffer 320 (step 440). The storage of the newly uploaded data in the circular buffer 320 assures the data redundancy in the file-based horizontal storage system 300 before parity data is calculated for the newly uploaded data. Once parity is calculated for the newly uploaded data, the parity data can be used to rebuild data lost in a particular data storage file silo 351-353. The newly uploaded data files stored in the circular buffer 320 can be deleted.

The information about the newly uploaded files is written to the data parity table (step 450). A parity table can include a list of file names stored in the file silos 351-353 and the status of their parity data. For example, the data file can be denoted a “No-Parity” status before parity data is calculated and stored in file silo 354. After data parity is computed and stored, the status for the data file can be changed to “Parity Stored”, as described below.

The parity builder 340 then checks the work loads of the transfer server 360 and the file silos 351-354 (step 460). If the workloads of the transfer server 360 and/or the file silos 351-354 are high (e.g. higher than a threshold value), the parity builder 340 can hold the parity computation. The workload status the transfer server 360 and the file silos 351-354 can be monitored. If the work loads are found to be low (e.g. lower than a threshold value), the parity builder can extract the newly uploaded data files from the circular buffer 320 and compute the parity data for the newly uploaded data files in accordance with the storage location of the newly uploaded data files across the file silos 351-353 (step 470).

The circular buffer 320 and the workload checking allow the file-based horizontal storage system 300 to be bigger capacity and increased efficiency in handling data uploads and storage, especially during the peak hours. The storage of the first set of data files in the file silos 351-353 can be made synchronously as new data files are uploaded. The parity calculation and parity data storage can be conducted asynchronously at minimal impact to the performance of the transfer server and file silos.

The parity data is subsequently written to the file silo 354 by the transfer server 360 (step 480). The parity table in the parity file storage 330 is then updated (step 490). The parity status for the newly uploaded data files can be changed from “No-Parity” to “Parity Stored”. Since the parity data stored in the file silo 354 provides the redundancy to the newly uploaded data files stored in the file silos 351-353, the newly uploaded data files stored in the circular buffer 320 can be deleted (step 500).

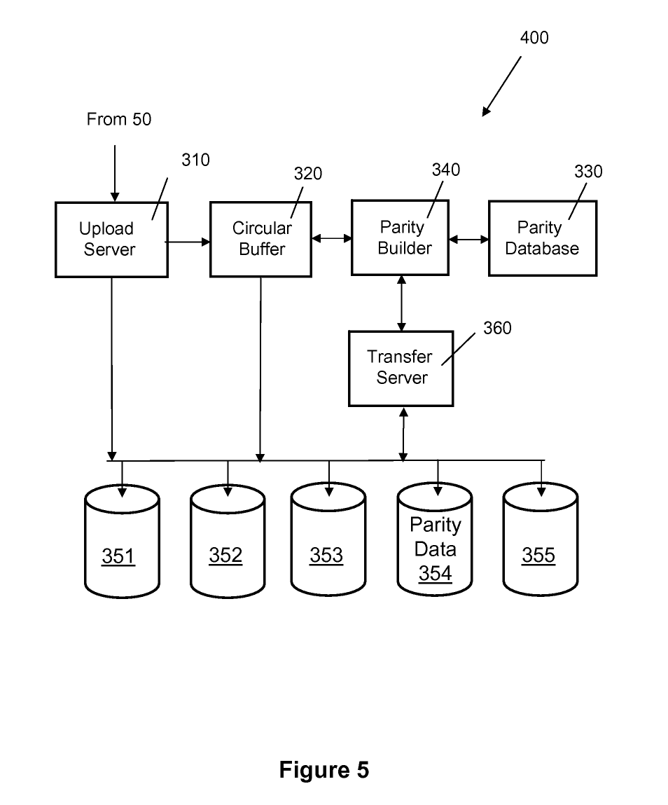

In some embodiments, the file-based horizontal storage system can also be easily scaled up with larger storage capacity without affect already stored data files while still properly maintaining data parity and data redundancy. For example, referring to FIG. 5, a new file silo 355 is added to the file-based horizontal storage system 300 to form a file-based horizontal storage system 400. As new file data is uploaded and stored in the file silo 355, the new file data is also stored in the circular buffer 320. The parity data can be computed for the file silos 351-353, and the file silo 355 without changing and retrieving the files stored in the file silos 351-353. The parity builder 340 can retrieve parity data from the filed silo 354 and the newly uploaded file data from the circular buffer 320. The parity builder 340 can then calculate a new set of parity data by adding the previous parity data to the newly uploaded file data. The new set of parity data can then be written to the file silo 354, wherein the old set of parity data can be removed.

It is understood that the above disclosed system and methods can be implemented in various forms without deviating from the spirit of the specification. For instance, the numbers of the above disclosed upload servers, file silos, circular buffer and transfer server are only meant to be for illustrating the concept. There can be different numbers of upload servers, the file silos, the circular buffers, and transfer servers. In addition, the data buffer for temporarily storing uploaded data files is not limited to a circular buffer. The data buffer can be implemented by many other types. Furthermore, the upload server, the file silos, the circular buffer, the transfer servers, and the parity file storage can be distributed at different geographic locations.

It is also understood that data parity storage can be arranged in many different configurations. Data parity on a file silo can cover file data stored in two, three, four, and other numbers of files silos. Data parity stored in a file silo can cover file data stored in different groups of file silos. For example, a portion of the parity data in file silo 354 can cover data stored in file silos 351-352. Another portion of the parity data in file silo 354 can cover data stored in file silos 353 and 355. Moreover, the status of parity data is not limited to a list of parity data files. The parity data can be stored in other configurations such as a data base. Furthermore, a data file in a data storage silo can be protected by parity data stored in more than one silo, which can provide additional redundancy and data protection. Furthermore, multiple copies of the same data file can be stored in different file silos 351-355.

It is also understood that data parity storage can be arranged in a distributed fashion. That is, in stead of storing parity data in a single file silo, parity data can be distributed in different file silos. Moreover, the file-based horizontal storage system can include dual parity data stored in different file silos to allow data recovery in the event of two drive failures.

What is claimed is:

1. A file-based storage system, comprising:
a upload server configured to receive data files;
a data buffer configured to store the data files received by the upload server;
a plurality of first file silos each configured to store at least a portion of the data files received by the upload server;
a parity builder configured to compute parity data corresponding to the portions of the data files stored in the plurality of first file silos; and
a second file silo configured to store parity data.

2. The file-based storage system of claim 1, further comprising a parity file storage configured to store the status of the parity data of the data files.

3. The file-based storage system of claim 1, wherein the status is configured to indicate whether a parity data for a data file is stored in the second file silo.

4. The file-based storage system of claim 1, further comprising a transfer server configured to store the parity data computed by the parity builder in the second file silo.

5. The file-based storage system of claim 1, wherein the parity builder is configured to compute parity data in accordance with the workloads of at least one of the plurality of the first file silos.

6. The file-based storage system of claim 1, wherein the parity builder is configured to delete the data files from the data buffer after the parity data is computed and stored in the second file silo.

7. The file-based storage system of claim 1, wherein the data buffer is a circular buffer.

8. The file-based storage system of claim 1, wherein the data files include file types compatible with Windows, MAC, and UNIX operating systems.

9. The file-based storage system of claim 1, wherein at least one of the plurality of the first file silos is configured to store more than a thousand data files.

10. The file-based storage system of claim 1, wherein the second file silo is configured to store a first portion of parity data for a first group of first file silos and to store a second portion of parity data for a second group of second file silos.

11. A file-based storage system, comprising:
a upload server configured to receive data files;
a plurality of first file silos each configured to store at least a portion of the data files received by the upload server;
a parity builder configured to compute parity data corresponding to the portions of the data files stored in the plurality of first file silos;
a second file silo configured to store parity data;
a parity file storage configured to store a status of the parity data, said status includes the completion of the computation of the parity data for the data files stored in the plurality of first file silos, and
a data buffer configured to store the data files received by the upload server, wherein the parity builder is configured to delete the data files in the data buffer when the status is stored in the parity file storage.

12. The file-based storage system of claim 11, wherein the status is configured to indicate whether a parity data for a data file is stored in the second file silo.

13. The file-based storage system of claim 11, further comprising a transfer server configured to store the parity data computed by the parity builder in the second file silo, wherein the parity builder is configured to compute parity data in accordance with the workload of at least one of the plurality of the first file silos and the transfer server.

14. The file-based storage system of claim 11, wherein the parity builder is configured to delete the data files from the data buffer after the parity data is computed and stored in the second file silo.

15. The file-based storage system of claim 11, wherein the data files include file types compatible with Windows, MAC, and UNIX operating systems.

16. The file-based storage system of claim 11, wherein at least one of the plurality of the first file silos is configured to store more than a thousand data files.

17. The file-based storage system of claim 11, wherein the second file silo is configured to store a first portion of parity data for a first group of first file silos and to store a second portion of parity data for a second group of second file silos.

18. A method for storing data files, comprising:
storing data files in a data buffer;
storing the data files in a plurality of first file silos;
determining the workload of at least one of the plurality of the first file silos;
computing parity data for the data files stored in the plurality of first file silos if the workload is below a threshold value;
storing the parity data in a second file silo; and
deleting the data files in the data buffer.

19. The method of claim 18, further comprising:
storing a first status of the parity data of the data files in a storage device before the step of computing; and
storing a second status of the parity data of the data files in a storage device after the step of computing and before the step of deleting.

20. The method of claim 18, further comprising:
storing a first portion of parity data for a first group of first file silos in the second file silo; and
storing a second portion of parity data for a second group of second file silo.
